(19) United States
(12) Patent Application Publication
(10) Pub. No.: US 2023/0116345 A1
(43) Pub. Date: Apr. 13, 2023

(54) SYSTEMS AND METHODS FOR ENTERPRISE WIDE RISK ASSESSMENT AND AGGREGATED RISK ANALYSIS

(71) Applicant: BetaRisk, Inc., Upper Marlboro, MD (US)

(72) Inventors: Ronald Sunungurai Chirochangu, Bromley (GB); Fungisai Mugwagwa, Bromley (GB)

(21) Appl. No.: 17/939,906

(22) Filed: Sep. 7, 2022

Related U.S. Application Data
(60) Provisional application No. 63/241,527, filed on Sep. 7, 2021.

(51) Int. Cl. G06Q 10/0635; G06Q 10/067; G06Q 10/0639; G06Q 10/0637

(52) U.S. Cl. CPC G06Q 10/0635; G06Q 10/067; G06Q 10/06393; G06Q 10/06375

(57) ABSTRACT

The present disclosure is for computing risk in a complex, multi-channel, and multi-portfolio environment. The process begins by ingesting company data, generating a plurality of portfolios based on the ingested company data, obtaining risk models, ingesting external data, computing risk scores and benchmarking risk scores to identify dominant risk models. Additionally, user input is received regarding any of the obtained data and standardized. The standardized data is used to compute an aggregate risk score which is sent to a plurality of stakeholders for real-time analysis and decision making.

### BACKGROUND

Within a given company, systems can lack intercommunication associated with risk variables which creates difficulty for a company with respect to obtaining a holistic view of risk. Often, a piecemeal analysis may be relied upon to evaluate risk factors in isolation without consideration of other company wide risk factors. This may result in a misleading or inaccurate risk overview because of interdependence of risk factors or multiple facets of a company. For example, risk factors from one department may affect another department however because of a lack of intercommunication between departments and their associated risks, a full risk analysis presents a challenge for many companies. In many cases, because of the lack of intercommunication and due to more piecemeal risk analysis, a company may miss rare combinations of unprecedented and even predictable events such that they fail to have a clear understanding of their risk exposure.

### SUMMARY

The systems and methods disclosed herein provide a novel approach to risk assessment and aggregated risk analysis which provide a holistic view of enterprise wide risk for a given company. As disclosed herein, company wide data associated with assets, liabilities and risk mitigation is obtained and analyzed in order to evaluate independent risk factors, interrelation between risk factors, primary and secondary risk drivers, an aggregate risk score, evaluate different risk outcomes based on different risk mitigation controls, and make recommendations to reduce risk. The novel concept(s) disclosed herein comprise obtaining enterprise wide company data, determining one or more risk source items and one or more risk impact items, evaluating interrelationships between risk source items and/or risk impact items, associating a score with each risk item, aggregating risk scores, adjusting risk scores based on risk mitigation strategies and/or projected company data, providing an aggregated risk assessment and making recommendations in association with mitigating risk as appropriate. Additionally, the present invention enables appropriate near real-time understanding and communication of risk based on company and external data. Real-time analysis is important for executing transactions and hedging risk as various developments occur.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system for risk assessment in accordance with an exemplary embodiment of the invention.

FIG. 2 illustrates a system for risk assessment in accordance with an exemplary embodiment of the present invention.

FIG. 3A illustrates an exemplary process for determining a risk assessment score according to one embodiment of the invention.

FIG. 3B illustrates an exemplary process for communicating risk assessment score data according to one embodiment of the invention.

FIG. 4 illustrates one embodiment of the computing architecture that supports an embodiment of the inventive disclosure.

FIG. 5 illustrates components of a system architecture that supports an embodiment of the inventive disclosure.

FIG. 6 illustrates components of a computing device that supports an embodiment of the inventive disclosure.

FIG. 7 illustrates components of a computing device that supports an embodiment of the inventive disclosure.

### DETAILED DESCRIPTION

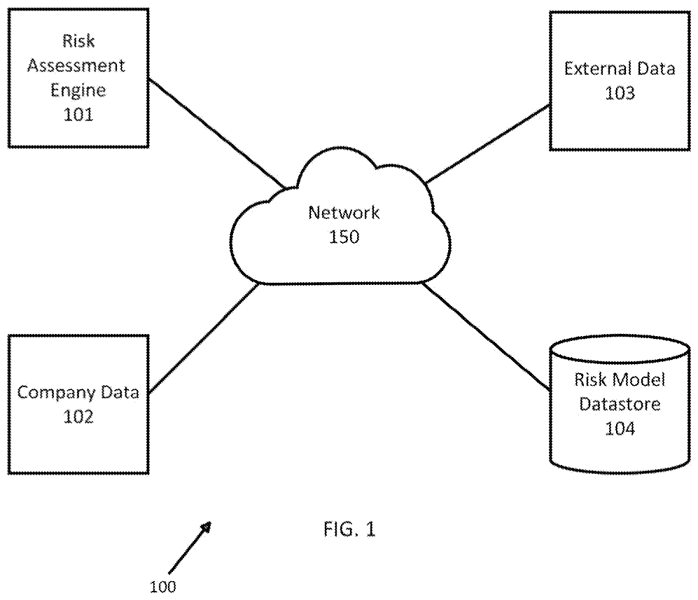

FIG. 1 illustrates an exemplary embodiment of a risk assessment system 100 according to one embodiment. The system includes risk assessment engine 101, company data 102, external data 103, risk model datastore 104, and a network 150 over which the various systems communicate and interact. The various computing devices described herein are exemplary and for illustration purposes only. The system may be reorganized or consolidated, as understood by a person of ordinary skill in the art, to perform the same tasks on one or more other servers or computing devices without departing from the scope of the invention.

Risk assessment engine 101 obtains company data, obtains external data, applies at least one risk model, and determines a risk assessment score based on the obtained data and risk model(s). Risk assessment engine 101 obtains data and models necessary for performing risk assessment through at least one application program interface (API). In general, risk assessment engine 101 determines risk for at least one of various risk impact categories from at least one of various risk source categories. In one aspect, risk impact categories comprise at least operational, financial, strategic, and regulatory aspects of a company. In one aspect, risk source categories comprise at least one of natural or climate factors, technological factors, biological factors, economic factors, and cybersecurity factors. Each of these source categories comprises a variety of risk items which may uniquely affect one or more risk impact categories for a given company. The above classification of risk items as belonging to a risk impact category or risk source category is merely exemplary and any risk item may be categorized as a risk impact or risk source. Risk assessment engine 101 is configured to determine which risk items are related to other risk items and categorize risk items appropriately based on at least one of whether they correlate with other risk items, are driven by other risk items, drive other risk items, and are driven by independent risk variables. Risk assessment engine 101 determines, for each risk item of each risk source category, which risk impact category(ies) would be affected, if any, an impact level the risk item has on the risk impact category, and a probability level of the risk item affecting the risk impact category. The risk assessment engine 101 further determines, from the impact level and the probability level, a priority level for each risk item. The risk assessment engine 101 also determines a total risk assessment score based on at least one of the impact level data, probability level data, and priority level data.

Company data 102 comprises general company information, assets, liabilities, and miscellaneous company data. General company information comprises at least one of company industry(ies), operating location(s), etc. Assets may comprise at least one of cash, cash equivalents, investments, inventory, accounts receivable, forecasted revenue, property, equipment, etc. Liabilities comprise at least one of debt, interest payable, accounts payable, forecasted expenses, taxes, employee wages and benefits, etc. Miscellaneous company data comprises any existing controls to mitigate risk, such as insurance policies, maintenance protocols, technology and equipment update/upgrade protocols, etc. In some aspects, insurance policies may be considered assets or liabilities depending on company industry and whether the associated insurance policies are issued to other entities or held by the company to provide coverage for the company.

External data 103 generally comprises data from outside a given company that in some way may impact the company. Examples of external data comprise climate data (e.g. natural disasters), news of cybersecurity issues, economic volatility (e.g. stock market fluctuations), regulatory data (e.g. new regulatory laws affecting a company's industry), etc.

Risk model datastore 104 stores at least one risk model associated with the risk source categories, risk impact categories, and risk items. Each risk model may be specific to a particular risk source category, risk item, or risk impact category. Alternatively, a risk model may factor in a plurality of risk source categories, risk items, and risk impact categories.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 421 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to clients devices or other devices in response to HTTP or other requests from clients devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

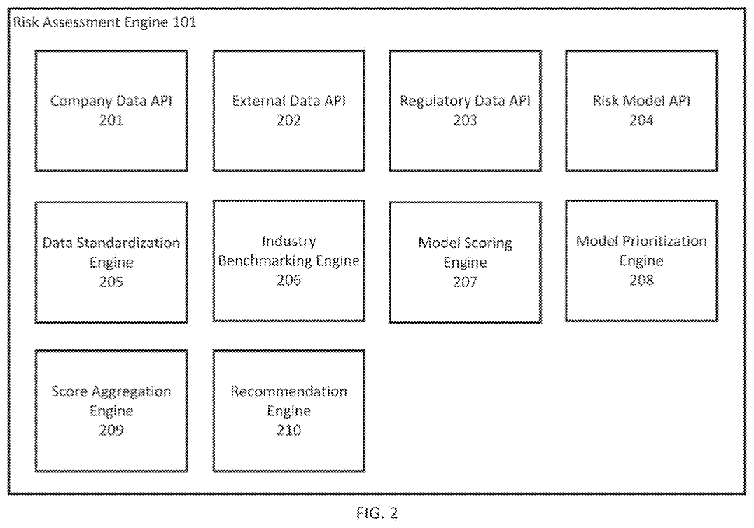

FIG. 2 illustrates an exemplary embodiment of the risk assessment engine 101. The risk assessment engine 101 comprises a company data API 201, external data API 202, regulatory data API 203, risk model API 204, data standardization engine 205, industry benchmarking engine 206, model scoring engine 207, model prioritization engine 208, score aggregation engine 209, and recommendation engine 210. Other systems and databases may be used, as would be readily understood by a person of ordinary skill in the art, without departing from the scope of the invention.

The company data API 201 obtains company data associated with performing risk assessment determinations. The company data API is configured to interact with a number of different company data platforms within a particular company or across different companies, wherein each data platform may provide data in a different format. The company data API 201 obtains company data such as that described above with respect to FIG. 1.

The external data API 202 obtains external data in association with the company and/or company data. In general, external data comprises macroeconomic data such as inflation and interest rates, sector level data, and risk level data associated with strategic risk, climate change risk, cyber security risk, etc. For example, based on company location data, external data API obtains climate information associated with the geographic region associated with company location data. As another example, external data API may obtain economic data such as stock market data associated with investment data of the company.

The regulatory data API 203 obtains regulatory data associated with any industry regulator which could affect a given company. Depending on the industry(ies) in which a company is involved, different regulatory data may be obtained so that the risk assessment engine can determine appropriate regulatory risks.

The risk model API 204 obtains at least one risk model, such as from a risk model datastore. A risk model may be specific to a particular risk source item or may consider multiple risk sources. In addition, a risk model may be specific to a particular risk impact category or may consider multiple risk impact categories. In one aspect, a risk model may be based on a correlation of risk items. For example, in one aspect, a multivariate correlation matrix may be generated by evaluating risk items in a pairwise fashion to determine the interrelation between each of a plurality of risk items. In one aspect, risk models comprise at least one of normal, parametric and Monte Carlo based modeling approaches. In one aspect, risk models are configured to determine volatility associated with at least one company asset, company liability, and/or other factors on which company operations depend. As one example, a risk model may be configured to track the value of an asset over time by obtaining data at multiple time points, determining variation in asset value over time, evaluating characteristics associated with the variation in asset value over time, determining a best fit for the variation data, and calculating a risk value associated with the asset based on the variation data.

The data standardization engine 205 aggregates obtained data from the above mentioned APIs and standardizes the data format. For example, each company may provide data in a different format depending on different platforms used by a company. Data standardization engine 205 analyzes obtained data and appropriately converts the data into a standardized format for further analysis with risk models. For example, this may comprise reordering data and mapping or categorizing data to appropriate risk sources, categories, types, etc.

The industry benchmarking engine 206 aggregates data across an industry to determine industry standards for use in assessing risk of a given company. Company data may be compared with an industry benchmark to determine if the company significantly differs in one or more aspects which may be an indication of increased risk. Industry benchmarking engine 206 may determine industry standards by analyzing data across a plurality of companies within a given industry in order to determine standard (e.g. average) benchmarks for the industry. Industry benchmarking engine 206 compares company data with the determined industry benchmark to determine if a company is within some threshold of the industry benchmark. If the determination indicates a company exceeds the threshold (i.e. the company is outside of the industry benchmark), the industry benchmarking engine may tag this comparison as a potential risk factor. In one aspect, industry benchmarking engine 206 evaluates risk scores determined by score aggregation engine 209 in order to determine standard risk scores for a given industry. These standard risk scores may be determined for each risk source category and each risk impact category. Industry benchmarking engine 206 then compares a given company's risk scores with the industry benchmark risk scores for each category to determine if a given company has risk scores similar to that of other companies in their industry.

The model scoring engine 207 determines at least one risk score in association with the obtained data. The model scoring engine 207 may determine a risk score for at least one risk item, each risk item associated with at least one of a risk source category, a risk impact category, a recurrence value (e.g. ongoing or one time), an impact level, a probability level, and a priority level. In one aspect, model scoring engine assigns a numerical value (e.g. 1-5) to the impact level and probability level and determines the priority level by multiplying the impact level by the probability level. In one aspect, model scoring engine 207 determines risk calculations based on existing risk mitigation controls. For example, model scoring engine 207 may modify at least one of the impact level, probability level and priority level of at least one risk item in association with risk mitigation policies/protocols associated with the at least one risk item. In one aspect, model scoring engine 207 determines at least one projected risk score in association with projected risk mitigation policies/protocols and/or projected strategies. For example, model scoring engine 207 may modify at least one of the impact level, probability level and priority level of at least one risk item in association with at least one risk mitigation plan, such as insurance policies, debt repayment plan, information technology upgrade protocols, etc.

The model prioritization engine 208 determines which risk factors are of highest priority. Prioritization may be assessed in a variety of ways. In one aspect, model prioritization engine determines priority based on the calculated priority level. In one aspect, model prioritization engine determines priority based on the cumulative priority levels for a particular risk source category or a particular risk impact category. In one aspect, model prioritization engine 208 generates a risk tree or risk hierarchy depicting the risks of greatest and least significance and any interdependence of one risk item on another risk item or of one risk item on another risk impact category.

The score aggregation engine 209 determines cumulative risk scores for each risk source category, each risk impact category, and an overall total risk score. In one aspect, score aggregation engine 209 sums the priority level of each risk item affecting operations, thereby generating a cumulative operations risk score. The same is also calculated for each of strategy, finance and regulatory risk impact categories, thereby providing an overview of which company aspects are associated with the greatest risk. In one aspect, score aggregation engine 209 sums the priority level of each risk item based on risk source category including but not limited to natural or climate risk, technological risk, biological risk, economic risk, and cybersecurity risk thereby providing an overview of which risk source categories pose greatest threat to a company. In one aspect, an overall total risk score is calculated thereby providing an overall measure of the risk exposure for a given company.

Recommendation engine 210 makes recommendations to mitigate risk. In one aspect, recommendation engine 210 makes recommendations based on the results of projected risk scores determined by model scoring engine 207. For example, in scenarios where model scoring engine 207 determines the difference between a projected risk score (based on a projected risk mitigation controls) and a current risk score (based on current risk mitigation controls) exceeds a threshold, the recommendation engine 210 makes a recommendation to implement the projected risk mitigation controls.

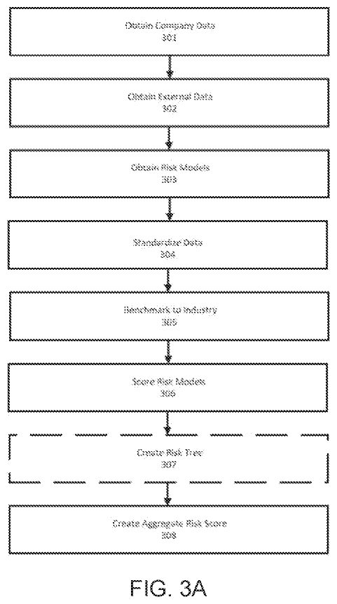

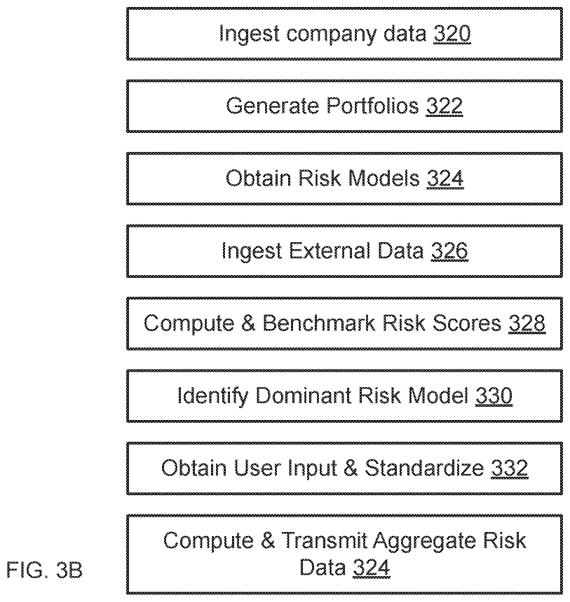

FIG. 3A illustrates an exemplary process for determining a risk assessment score for a company. The process comprises obtaining company data 301, obtaining external data 302, obtaining risk models 303, standardizing data 304, benchmarking to industry standards 305, scoring risk models 306, optionally creating a risk tree 307, and creating an aggregate risk score 308.

At step 301, the process comprises obtaining company data 301. Company data generally comprises data that would be relevant to assessing risk including but not limited to company industry(ies), operating location(s), cash, cash equivalents, investments, inventory, accounts receivable, forecasted revenue, property, equipment, debt, interest payable, accounts payable, forecasted expenses, taxes, employee wages and benefits, and any existing controls to mitigate risk, such as insurance policies and maintenance/upgrade protocols.

At step 302, the process comprises obtaining external data 302. External data generally comprises data which is not specific to a company, but rather with outside factors which could have an impact on a company. External data comprises climate data associated with the company, regulatory requirements associated with the industry of the company, economic factors associated with the company, etc.

At step 303, the process comprises obtaining risk models associated with the obtained company and external data. Risk models may be specific to a particular risk source item or impact category or may consider multiple risk sources and impact categories. Risk models may be configured to provide an assessment of current risk status (e.g. a snapshot) or may be configured to provide an assessment of future risk (e.g. forecast) such as by using AI and ML.

At step 304, obtained data is standardized into a format usable for risk model processing. Each company may provide data in a different format or data received from a single company may be in different formats due to different company platforms being used for different departments. Therefore, it is necessary to ensure all data is reordered and organized into a standard format for further processing.

At step 305, company data is benchmarked to industry standards. In one aspect this comprises analyzing company data and identifying differences and similarities between a company and established standards for the company's industry. In one aspect, this step may be done after step 306 and use risk model scores to determine if a company has significantly more or less risk than companies in the same industry or has significantly different risk sources and risk impact categories than companies in the same industry.

At step 306, risk models are implemented to produce at least one risk score. As discussed above, different risk models can be implemented, thus a set of risk scores can be determined such as for each risk source category and for each risk impact category.

At step 307, a risk tree may be generated showing a risk hierarchy or risk prioritization based on the scoring of the risk models. This may comprise a visual depiction of the risks most likely to affect a given company based on current data or may be used to depict potential future risk based on risk projections.

At step 308, aggregate risk score(s) is/are determined. In one aspect this comprises determining a total risk score for each risk source category, for each risk impact category, and an overall total risk score. In this way, a holistic view of all risk components can be assessed and presented.

FIG. 3B illustrates an exemplary embodiment for standardizing and communicating risk data. As discussed above, risk is a very difficult thing to conceptualize in the relevant industries. Moreover, there is no standardized definition of risk and everyone inputs risk related data based on systems and computing resources available to them. The present invention standardizes risk, and enables near real time computing and transmission of risk data. The real-time availability of this data is critical as it may change based on quickly changing situations and may need to be modeled in near real time for accurate forecasting and hedging.

At step 320, the system ingests company data. In one embodiment, ingesting company data comprises of ingesting at least a chart of accounts. It may further continue by identifying a list of assets, identifying asset groups associated with each identified asset, and identifying asset classes associated with each identified liability as well as identifying list of liabilities, identifying liability group associated with each identified liability, and identifying a liability class associated with each identified liability.

In one embodiment, ingesting company data 320 is further comprised of configuring a plurality of ratios, including, but not limited to (1) profitability ratios: gross margin ratio, operating margin ratio, return on assets ratio, return on equity ratio, (2) liquidity ratios: current ratio, liquid test ratio, cash ratio, operating cash flow ratio, solvency/leverage ratios, debt ratio, debt to equity ratio, interest coverage ratio, debt service coverage ratio, (3) efficiency ratios: asset turnover ratio, inventory turnover ratio, receivables turnover ratio, days sales in inventory ratio, (4) market value ratio: book value per share ratio, dividend yield ratio, earnings per share ratio, price-earning ratio, (5) turnover ratios: asset turnover ratio, inventory turnover ratio, receivables turnover ratio, days sales in inventory ratio, etc.

In one embodiment, company data may be ingested via, for example, but not limited to: an application programming interface (API), a data scraping technique, data integration, and comma separated values (CSV) import. In one embodiment, the API is capable of providing text checking functionality to a plurality of programs. An input means provides access to text from the program to the API. Preferably, the input means includes an input buffer that communicates with a program to receive text from the application program. An input buffer pointer is provided for addressing the text in the input buffer. The input buffer pointer is passed to a text checking engine, which preferably is part of the API. The text checking engine performs a text checking function requested by the application program and provides information responsive to the requested function. A return buffer communicates with the text checking engine to receive the information from the engine together with other information provided by the API. The return buffer also communicates with the program to allow the program to retrieve the responsive information from the return buffer. Preferably, a clean bit is attached to each group of words checked if no errors are found in the group by the engine. One embodiment of the API includes a checking module, an input buffer 18, and a return buffer. The input buffer is a block of memory that receives text to be checked from any one of the program. The return buffer is a block of memory that stores information to be passed to the program in response to the text checking functions requested. The checking module includes a set of routines that performs the actions required for text checking, each of the routines being callable by any of the programs.

At step 322, a portfolio may be generated based on the ingested data. In one embodiment, each portfolio has a risk category and/or each portfolio has an associated industry sector. For example, all the real estate holdings on a company's asset sheet may be categorized under a real estate industry sector portfolio. Additionally, a risk category for real estate may be applied to the portfolio. In one embodiment, each portfolio is comprised of the following data: accrued interest, duration, effective duration, interest rate delta, market value, market value percentage, nominal, convexity, equity delta, key rate duration, modified duration, spread delta, spread duration, and time to maturity.

At step 324 risk models that are appropriate to each portfolio may be applied to each portfolio. A variety of risk models may be used, as would be understood by a person of ordinary skill in the art, including, but not limited to: (1) market risk, such as VaR, marginal VaR, conditional VaR/Expected shortfall, beta, sharpe ratio, interest rate risk/currency risk, correlation, delta, volatility, exposure rate, recovery rate, standard deviation, Sharpe ratio, Sortino ratio, Treynor ratio, beta ratio, value at risk, conditional value at risk, r-squared, and MSCI Barra, (2) credit risk such as probability of default, loss given default, exposure at default, (3) liquidity risk, such as quick ratio, current ratio, debt to equity ratio, (4) operational risk, such as regulatory risk, (5) strategic risk, such as risk-adjusted return on capital.

At step 326 external data may be ingested. The external data may be obtained based on risk models. A variety of external data may be obtained, as would be understood by a person of ordinary skill in the art, including, but not limited to geographic climate risk data, exchange rate and currency data, regulatory data, and economic factors.

At step 328 a risk score is computed for each applied risk model for each portfolio. In one embodiment, the risk score is based on ingested company data, the risk model, and the ingested external data. Additionally, the risk score may be benchmarked to other portfolios in the same industry sector. For example, a real estate portfolio may be compared to other real estate portfolios for benchmarking purposes.

At step 330 a dominant risk model may be identified for each portfolio based on the benchmarking data. A variety of different dominant risk models may be identified including, but not limited to: (1) market risk, such as VaR, marginal VaR, conditional VaR/Expected shortfall, beta, sharpe ratio, interest rate risk/currency risk, correlation, delta, volatility, exposure rate, recovery rate, (2) credit risk such as probability of default, loss given default, exposure at default, (3) liquidity risk, such as quick ratio, current ratio, debt to equity ratio, (4) operational risk, such as regulatory risk, (5) strategic risk, such as risk-adjusted return on capital.

At step 332 user input may be received and may be standardized. For example, the step may comprise providing remote access to users over a network so any one of the users can update information about the ingested company data, the ingested external data, and risk model data, wherein the one of the users provides the update information in a non-standardized format depending on at least one of the hardware and platform used by the one of the users, and the risk model available to the one of the users. In one embodiment, the obtained input data, the obtained company data, the obtained external data, the obtained risk model data, and the non-standardized update information into a standardized format.

At step 324, an aggregate risk is automatically computed. In one embodiment, the aggregate risk score is based on ingested company data, obtained risk model data, and standardized update information. Additionally, the aggregate risk score is automatically sent to various stakeholders in near real time so that the plurality of users have near immediate access to the aggregated risk score.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, components or the like may be and/or comprise hardware and/or software as described herein.

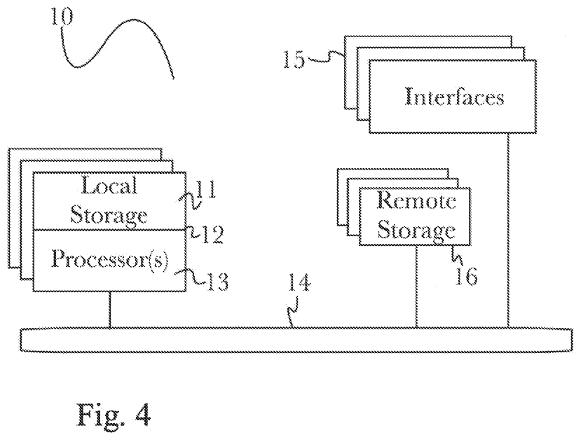

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 4 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Per, Ruby, Groovy, or any other scripting language).

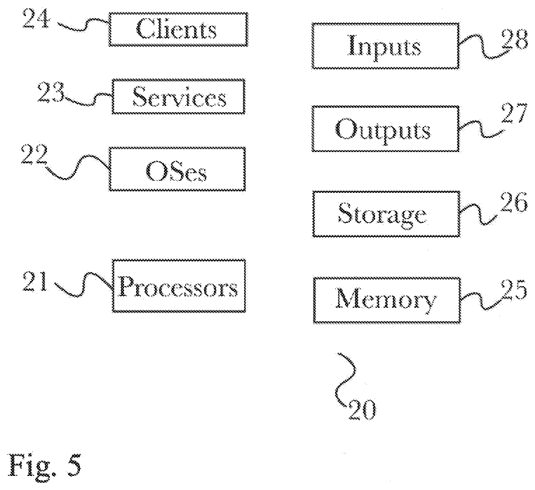

In some embodiments, systems may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 4). Examples of storage devices 26 include flash memory, magnetic hard drive, CD-ROM, and/or the like.

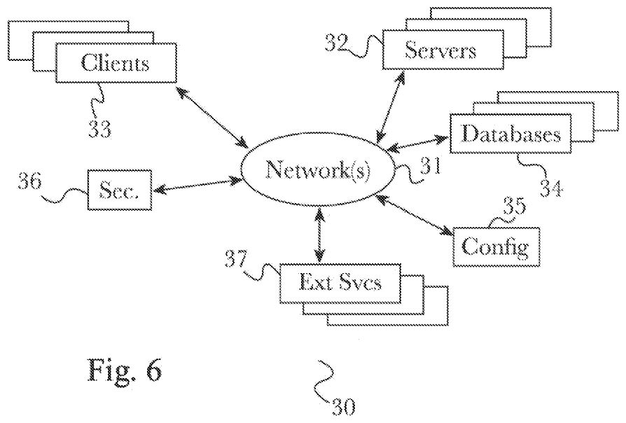

In some embodiments, systems may be implemented on a distributed computing network, such as one having any number of clients and/or servers. Referring now to FIG. 6, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 5. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

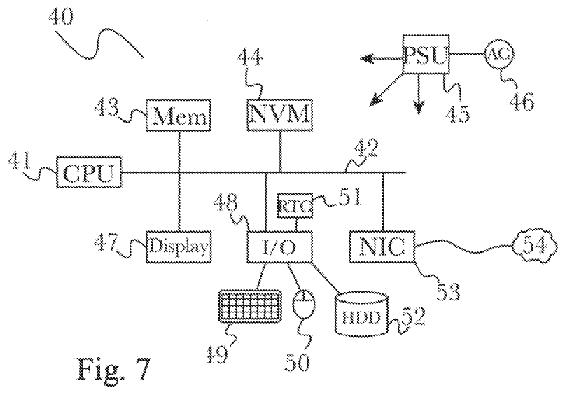

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computer implemented method for enabling near real-time transmission and communication of risk in a complex, multi-channel, and multi-portfolio environment, the computer implemented method comprising:
ingest company data
generate a plurality of portfolios based on ingested company data, each portfolio having a risk category and each portfolio having an associated industry sector;
apply at least one risk model to each portfolio by ingesting external data, the risk model enabling a computation of risk, the ingested external data related being related to each risk model;
obtain a risk score for each applied risk model for each portfolio, the risk score based on ingested company data, the risk model, and the ingested external data;
compare the risk score for each portfolio in each industry sector with other portfolios in the same industry sector;
providing remote access to users over a network so any one of the users can update information about the ingested company data, the ingested external data, and risk model data, wherein the one of the users provides the update information in a non-standardized format depending on at least one of the hardware and platform used by the one of the users, and the risk model available to the one of the users;
converting the obtained company data, the obtained external data, the obtained risk model data, and the non-standardized update information into a standardized format;
automatically computing an aggregate risk score based on ingested company data, obtained risk model data, and standardized update information;
automatically generating a message containing the aggregate risk score whenever new company data, new external data, risk model data, or update information data is obtained; and
transmitting the message to a plurality of users over the computer network in near real time, so that the plurality of users have near immediate access to the aggregated risk score.

2. The computer-implemented method of claim 1, wherein ingesting company data comprises of ingesting at least a chart of accounts.

3. The computer-implemented method of claim 1, wherein ingesting company data is comprised of identifying a list of assets, identifying asset groups associated with each identified asset, and identifying asset classes associated with each identified liability.

4. The computer-implemented method of claim 1, wherein ingesting company data is comprised of identifying list of liabilities, identifying liability group associated with each identified liability, and identifying a liability class associated with each identified liability.

5. The computer-implemented method of claim 1, wherein ingesting company data is comprised of configuring a plurality of ratios.

6. The computer-implemented method of claim 5, wherein the computed ratios comprise of at least one of profitability ratios, liquidity ratios, solvency/leverage ratios, efficiency ratios, and market value ratios.

7. The computer-implemented method of claim 1, wherein the company data is ingested via at least one of an application programming interface (API), a data scraping technique, data integration, and comma separated values (CSV) import.

8. The computer-implemented method of claim 1, wherein the various risk models comprise at least one of, standard deviation, Sharpe ratio, Sortino ratio, Treynor ratio, beta ratio, value at risk, conditional value at risk, r-squared, and MSCI Barra.

9. The computer-implemented method of claim 1, wherein the ingested external data is comprised of at least one of, geographic climate risk data, exchange rate and currency data, regulatory data, and economic factors.

10. The computer-implemented method of claim 1, wherein each portfolio is comprised of the following data: accrued interest, duration, effective duration, interest rate delta, market value, market value percentage, nominal, convexity, equity delta, key rate duration, modified duration, spread delta, spread duration, and time to maturity.

11. The computer-implemented method of claim 1, wherein comparing the risk score for each portfolio in each industry sector with other portfolios in the same industry sector is further comprised of identifying a dominant risk identifying a dominant risk model for each portfolio.

12. A computer program product for for enabling near real-time transmission and communication of risk in a complex, multi-channel, and multi-portfolio environment, the computer program product comprising a non-transitory computer readable storage medium having instructions encoded thereon that, when executed by a processor, cause the processor to:
ingest company data generate a plurality of portfolios based on ingested company data, each portfolio having a risk category and each portfolio having an associated industry sector;
apply at least one risk model to each portfolio by ingesting external data, the risk model enabling a computation of risk, the ingested external data related being related to each risk model;
obtain a risk score for each applied risk model for each portfolio, the risk score based on ingested company data, the risk model, and the ingested external data;
compare the risk score for each portfolio in each industry sector with other portfolios in the same industry sector;
providing remote access to users over a network so any one of the users can update information about the ingested company data, the ingested external data, and risk model data, wherein the one of the users provides the update information in a non-standardized format depending on at least one of the hardware and platform used by the one of the users, and the risk model available to the one of the users;
converting the obtained company data, the obtained external data, the obtained risk model data, and the non-standardized update information into a standardized format;
automatically computing an aggregate risk score based on ingested company data, obtained risk model data, and standardized update information;
automatically generating a message containing the aggregate risk score whenever new company data, new external data, risk model data, or update information data is obtained; and
transmitting the message to a plurality of users over the computer network in near real time, so that the plurality of users have near immediate access to the aggregated risk score.

13. The computer program product of claim 12, wherein ingesting company data comprises of ingesting at least a chart of accounts.

14. The computer program product of claim 12, wherein ingesting company data is comprised of identifying a list of assets, identifying asset groups associated with each identified asset, and identifying asset classes associated with each identified liability.

15. The computer program product of claim 12, wherein ingesting company data is comprised of identifying list of liabilities, identifying liability group associated with each identified liability, and identifying a liability class associated with each identified liability.

16. The computer program product of claim 12, wherein ingesting company data is comprised of configuring a plurality of ratios.

17. The computer program product of claim 16, wherein the computed ratios comprise of at least one of profitability ratios, liquidity ratios, solvency/leverage ratios, efficiency ratios, and market value ratios.

18. The computer program product of claim 12, wherein the company data is ingested via at least one of an application programming interface (API), a data scraping technique, data integration, and comma separated values (CSV) import.

19. The computer program product of claim 12, wherein the various risk models comprise at least one of, standard deviation, Sharpe ratio, Sortino ratio, Treynor ratio, beta ratio, value at risk, conditional value at risk, r-squared, and MSCI Barra.

20. The computer program product of claim 12, wherein the ingested external data is comprised of at least one of, geographic climate risk data, exchange rate and currency data, regulatory data, and economic factors.
